(19) United States
(12) Patent Application Publication
(10) Pub. No.: US 2026/0177022 A1
(43) Pub. Date: Jun. 25, 2026

(54) CANISTER

(71) Applicant: FUTABA INDUSTRIAL CO., LTD., Okazaki-shi (JP)

(72) Inventor: Koji Iwamoto, Okazaki-shi (JP)

(21) Appl. No.: 19/401,687

(22) Filed: Nov. 26, 2025

(30) Foreign Application Priority Data
Dec. 24, 2024 (JP) 2024-227571

(51) Int. Cl. F02M 25/08

(52) U.S. Cl. CPC F02M 25/0854

(57) ABSTRACT

A canister is configured to adsorb and desorb an evaporated fuel generated in a fuel tank of a vehicle and includes a case and at least one reinforcing member. The case includes therein a chamber, in which an adsorbent for the evaporated fuel is disposed, and also includes a charge port that takes in the evaporated fuel, a purge port that discharges the evaporated fuel, and an atmosphere port that is open to atmosphere. The at least one reinforcing member is a long and narrow member situated on a wall of the case facing the chamber. A material of the at least one reinforcing member has higher stiffness than a material of the case.

### CROSS-REFERENCE TO RELATED APPLICATIONS

This application claims the benefit of Japanese Patent Application No. 2024-227571 filed on Dec. 24, 2024 with the Japan Patent Office, the entire disclosure of which is incorporated herein by reference.

### BACKGROUND

The present disclosure relates to a canister.

In recent years, as vehicles become more highly functional, the space available for installing a canister in vehicles is decreasing, resulting in requiring the canister to be flat-shaped or downsized. However, having the canister flat-shaped may lead to a reduction in stiffness of the canister.

Meanwhile, a canister disclosed in Japanese Unexamined Patent Application Publication No. 2021-076015 includes a rib protruding from an outer surface of a case. Such a rib can improve stiffness of a case of the flat-shaped canister.

### SUMMARY

In order to effectively improve the stiffness of the canister disclosed in Japanese Unexamined Patent Application Publication No. 2021-076015, it is desirable to increase the height of the rib rather than increasing an area of a portion on an outer circumferential surface of the canister where the rib is situated. However, in a case where the height of the rib is increased, there may be a risk of increasing a space necessary to install the canister in a vehicle.

In one aspect of the present disclosure, it is desirable to improve stiffness of a canister while inhibiting a decrease in installability of the canister to a vehicle.

One mode of the present disclosure is a canister that adsorbs and desorbs an evaporated fuel generated in a fuel tank of a vehicle. The canister includes a case and at least one reinforcing member. The case includes therein a chamber, in which an adsorbent for the evaporated fuel is disposed, and also includes a charge port that takes in the evaporated fuel, a purge port that discharges the evaporated fuel, and an atmosphere port that is open to atmosphere. The at least one reinforcing member is a long and narrow member situated on a wall of the case facing the chamber. The material of the at least one reinforcing member has higher stiffness than the material of the case.

According to the aforementioned configuration, the case can be reinforced while minimizing an increase in the material of the case. Thus, it is possible to improve strength of the canister while inhibiting a decrease in installability of the canister to the vehicle.

In one mode of the present disclosure, the chamber may include a first chamber having a flat shape. A portion of the wall of the case forming the first chamber may include two wide-width portions and two narrow-width portions. The wide-width portions may face each other in thickness directions that are perpendicular to fluid flow directions. The narrow-width portions may face each other in width directions that are perpendicular to the fluid flow directions and the thickness directions. The interval between the two wide-width portions in the thickness directions may be narrower than the interval between the two narrow-width portions in the width directions. The at least one reinforcing member may be situated on at least one of the two wide-width portions.

There is a risk that the wall forming the first chamber having a flat shape dilates or bends. However, according to the aforementioned configuration, the wide-width portions forming the first chamber can be favorably reinforced. Thus, it is possible to inhibit the wide-width portions from dilating and bending.

In one mode of the present disclosure, the first chamber may include the charge port and the purge port.

It is necessary to ensure that the first chamber, where the charge port and the purge port are disposed, has an adequate volume. In this respect, according to the aforementioned configuration, the case can be favorably reinforced since the at least one reinforcing member is situated on the first chamber which has a larger volume.

In one mode of the present disclosure, the at least one reinforcing member may be made of metal.

According to the aforementioned configuration, the case can be favorably reinforced.

In one mode of the present disclosure, the at least one reinforcing member may be made of a resin containing a glass fiber.

According to the aforementioned configuration, the case can be favorably reinforced.

In one mode of the present disclosure, each of the at least one reinforcing member may be embedded into the wall of the case such that a part of each of the at least one reinforcing member is exposed outside. A part of each of the at least one reinforcing member embedded into the wall may include a recessed portion and/or a projected portion.

According to the aforementioned configuration, the wall can be made thin compared to a case where a whole of the at least one reinforcing member is embedded into the wall. Thus, it is possible to inhibit an increase in the volume of materials to form the case. Accordingly, it is possible to reduce the space for installing the canister in the vehicle and to reduce the weight of the canister.

In one mode of the present disclosure, each of the at least one reinforcing member may be situated on the wall of the case by engaging with an engagement portion disposed on an outer circumferential surface of the wall of the case.

According to the aforementioned configuration, it is possible to favorably attach the at least one reinforcing member to the wall of the case.

In one mode of the present disclosure, the at least one reinforcing member may include two or more reinforcing members. The two or more reinforcing members may be arranged side by side with one another in a given direction.

According to the aforementioned configuration, it is possible to favorably reinforce the case.

In one mode of the present disclosure, the at least one reinforcing member may include two or more reinforcing members. The two or more reinforcing members may be arranged side by side with one another in a given direction on at least one of the two wide-width portions.

According to the aforementioned configuration, it is possible to favorably reinforce the case.

In one mode of the present disclosure, the two or more reinforcing members may be arranged side by side with one another substantially in the fluid flow directions.

According to the aforementioned configuration, it is possible to favorably reinforce the case.

In one mode of the present disclosure, the two or more reinforcing members may be arranged side by side with one another substantially in the width directions.

According to the aforementioned configuration, it is possible to favorably reinforce the case.

### BRIEF DESCRIPTION OF THE DRAWINGS

Example embodiments of the present disclosure will be described hereinafter with reference to the accompanying drawings, in which:

FIG. 1A is a perspective view of a canister in a first embodiment;

FIG. 1B is an enlarged perspective view of an end portion of a reinforcing member and its vicinity in the first embodiment;

FIG. 2 is a side view of the canister in the first embodiment viewed from a first vertical wall side;

FIG. 3A is a cross-sectional view of a reinforcing member and a base in the first embodiment taken perpendicular to width directions;

FIG. 3B is a cross-sectional view of a reinforcing member and a base in a modified example of the first embodiment taken perpendicular to the width directions;

FIG. 3C is a perspective view of a canister in a second embodiment;

FIG. 4A is an enlarged perspective view of a reinforcing member and an engagement portion in the second embodiment;

FIG. 4B is a cross-sectional view of the reinforcing member and the engagement portion in the second embodiment taken perpendicular to the width directions;

FIG. 4C is a cross-sectional view of a reinforcing member and an engagement portion in a modified example 1 of the second embodiment taken perpendicular to the width directions;

FIG. 4D is a cross-sectional view of the reinforcing member and the engagement portion in the modified example 1 of the second embodiment taken perpendicular to the width directions;

FIG. 5A is a cross-sectional view of a reinforcing member and an engagement portion in a modified example 2 of the second embodiment taken perpendicular to the width directions;

FIG. 5B is a perspective view of the reinforcing member in the modified example 2 of the second embodiment;

FIG. 5C is a cross-sectional view of the reinforcing member and the engagement portion in the modified example 2 of the second embodiment taken perpendicular to the width directions;

FIG. 5D is a perspective view of the reinforcing member in the modified example 2 of the second embodiment;

FIG. 6A is a perspective view of a canister in a third embodiment;

FIG. 6B is a perspective view of the canister in the third embodiment; and

FIG. 7 is a perspective view of a canister in another embodiment.

### DETAILED DESCRIPTION OF EXEMPLARY EMBODIMENTS

### 1. First Embodiment

### [(1) Overview]

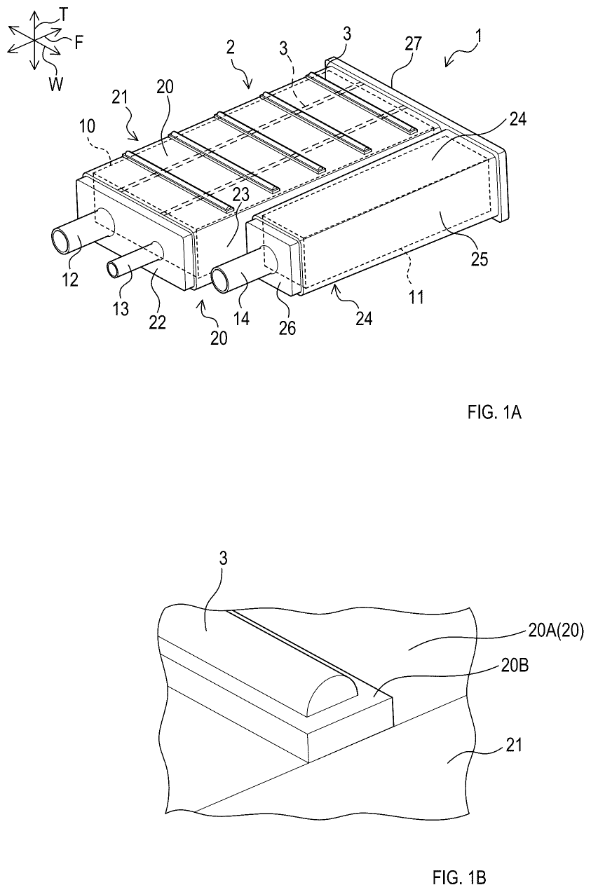

A canister 1 in a first embodiment is an evaporated fuel treatment device that adsorbs and desorbs an evaporated fuel generated in a fuel tank of a vehicle (see FIG. 1A). The canister 1 includes a first chamber 10, a second chamber 11, a charge port 12, a purge port 13, an atmosphere port 14, and a case 2.

### <Case>

As one example, the case 2 is an enclosure made of resin and includes the charge port 12, the purge port 13, and the atmosphere port 14 on a first end of the case 2 in fluid flow directions F (see FIG. 1A).

The case 2 further includes two first horizontal walls 20, a first vertical wall 21, a first end wall 22, an intermediate wall 23, two second horizontal walls 24, a second vertical wall 25, and a second end wall 26. A first and second chambers 10, 11 are formed inside these walls. In other words, these walls face both or either one of the first and second chambers 10, 11. In addition, these walls form an opening on a second end of the case 2 in the fluid flow directions F. The opening is closed with a lid 27.

The first and second chambers 10, 11 also include an adsorbent (for example, an activated carbon) disposed therein, the adsorbent being capable of adsorption and desorption of the evaporated fuel. The adsorbent contained in a case may be disposed in the first chamber 10 and/or the second chamber 11.

### <Ports>

The charge port 12 is coupled to the fuel tank of the vehicle by piping (see FIG. 1A). The charge port 12 takes the evaporated fuel generated in the fuel tank into the canister 1.

The purge port 13 is coupled to an intake pipe of an engine of the vehicle via a purge valve. The evaporated fuel adsorbed by the adsorbent in the first and second chambers 10, 11 is discharged from the purge port 13 by an intake negative pressure of the engine and supplied to the engine.

The atmosphere port 14 is open to the atmosphere and discharges air, from which the evaporated fuel is removed in the canister 1, to the atmosphere. The atmosphere port 14 takes outside air (hereinafter, purge air) in the first and second chambers 10, 11, and the purge air desorbs the evaporated fuel adsorbed by the adsorbent inside the first and second chambers 10, 11.

### <First Chamber>

The first chamber 10 provides a space having an approximately rectangular parallelepiped flat shape that extends along the fluid flow directions F and width directions W perpendicular to the fluid flow directions F (see FIG. 1A). The adsorbent is disposed in the first chamber 10. The first chamber 10 is formed by the two first horizontal walls 20, the first vertical wall 21, the first end wall 22, and the intermediate wall 23 of the case 2.

The two first horizontal walls 20 are approximately rectangular wall portions that face each other in thickness directions T perpendicular to the fluid flow directions F and the width directions W.

The first vertical wall 21 and the intermediate wall 23 are long and narrow wall portion having an approximately rectangular shape and extending in the fluid flow directions F. The first vertical wall 21 and the intermediate wall 23 face each other in the width directions W.

The first end wall 22 is an approximately rectangular shaped wall portion situated in a first end of the first chamber 10 in the fluid flow directions F.

These walls 20 to 23 surround the first chamber 10 and form an opening in a second end of the first chamber 10 in the fluid flow directions F. A permeable filter and a partition plate are arranged in the opening. The charge port 12 and the purge port 13 are situated on the first end wall 22 and communicate with the first chamber 10.

The first chamber 10 has a flat shape extending along the two first horizontal walls 20. The interval between the two first horizontal walls 20 in the thickness directions T is narrower than the interval between the first vertical wall 21 and the intermediate wall 23 in the width directions W. In other words, each of the first horizontal walls 20 (that are, wide-width portions) is wider than the first vertical wall 21 and the intermediate wall 23 (that are, narrow-width portions).

### <Second Chamber>

The second chamber 11 provides a long and narrow space having an approximately rectangular parallelepiped shape extending in the fluid flow directions F. The second chamber 11 is arranged alongside the first chamber 10 in the width directions W. The adsorbent for the evaporated fuel is disposed in the second chamber 11 (see FIG. 1A). The second chamber 11 is formed by the intermediate wall 23, the two second horizontal walls 24, the second vertical wall 25, and the second end wall 26 of the case 2.

The two second horizontal walls 24 are long and narrow wall portions having an approximately rectangular shape and extending in the fluid flow directions F. The two second horizontal walls 24 face each other in the thickness directions T.

The second vertical wall 25 is a long and narrow wall portion having an approximately rectangular shape and extending in the fluid flow directions F. The second vertical wall 25 faces with the intermediate wall 23 in the width directions W. In other words, the intermediate wall 23 divides the first chamber 10 and the second chamber 11 from each other. However, without being limited to the aforementioned configuration, a wall portion forming the first chamber 10 and a wall portion forming the second chamber 11 may be arranged between the first chamber 10 and the second chamber 11 so as to overlap each other in the width directions W.

The second end wall 26 is an approximately rectangular shaped wall portion situated in a first end of the second chamber 2 in the fluid flow directions F.

These walls 23 to 26 surround the second chamber 2 and form an opening in a second end of the second chamber 2 in the fluid flow directions F. Similarly to the first chamber 10, a permeable filter and a partition plate are arranged in the opening. The atmosphere port 14 is situated on the second end wall 26 and communicates with the second chamber 11.

### <Communication Path>

A communication path for communication between the first chamber 10 and the second chamber 11 is disposed between the lid 27 and the second end of the first and second chambers 10, 11 in the fluid flow directions F (not illustrated). A spring or the like is arranged in the communication path, the spring or the like holds the activated carbon disposed in each of the first and second chambers 10, 11 by pressing the partition plates situated in the second ends of the first and second chambers 10, 11 toward the first ends of the first and second chambers 10, 11 in the fluid flow directions F.

### [(2) Reinforcing Member]

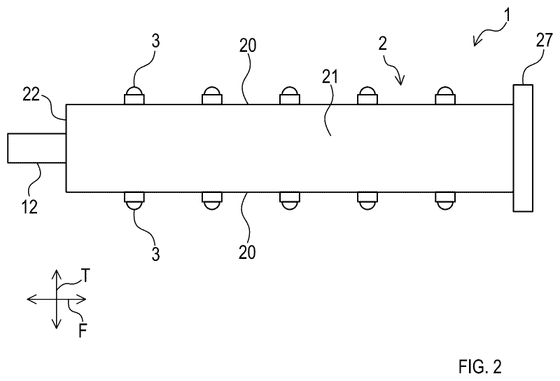

Each of the first horizontal walls 20 of the case 2 includes two or more of long and narrow reinforcing members 3 (see FIG. 1A, FIG. 1B, FIG. 2). Each of the reinforcing members 3 is configured as a rod-like portion in one example, however, without being limited to this configuration, each of the reinforcing members 3 may be a long and narrow plate-shaped portion, for example. The shape of a cross section of each of the reinforcing members 3 taken perpendicular to its extending directions can be appropriately determined, for example, a circular shape, a polygonal shape, or the like. The material of each of the reinforcing members 3 has higher stiffness than a resin that forms the case 2. Specifically, the material of each of the reinforcing members 3 may be a metal, or a resin whose stiffness is improved by containing a glass fiber, for example.

In one example, each of the reinforcing members 3 is disposed to extend substantially in the width directions W and extends from a vicinity of a first end of each of the first horizontal walls 20 in the width directions W to a vicinity of a second end of each of the first horizontal walls 20 in the width directions W. The reinforcing members 3 are arranged side by side substantially in the fluid flow directions F at roughly constant intervals. Without being limited to this configuration, the reinforcing members 3 may extend substantially in the fluid flow directions F and may be arranged side by side with each other substantially in the width directions W for example.

However, without being limited to this configuration, the orientation and the position of each of the reinforcing members 3 are appropriately determined. The number of the reinforcing member 3 disposed on each of the first horizontal walls 20 can be appropriately determined. A single reinforcing member 3 may be arranged on each of the first horizontal walls 20. Alternatively, two or more reinforcing members 3 may be disposed on one of the first horizontal walls 20, or, a single reinforcing member 3 or two or more reinforcing members 3 may be disposed on a wall other than the first horizontal walls 20.

### <Arrangement of Reinforcing Members>

In one example, each of the reinforcing members 3 is disposed on a corresponding one of the first horizontal walls 20 by insert-molding. Each of the reinforcing members 3 is arranged on an outer circumferential surface 20A of the corresponding one of the first horizontal walls 20 with a part of each of the reinforcing members 3 being exposed outside (see FIG. 1B).

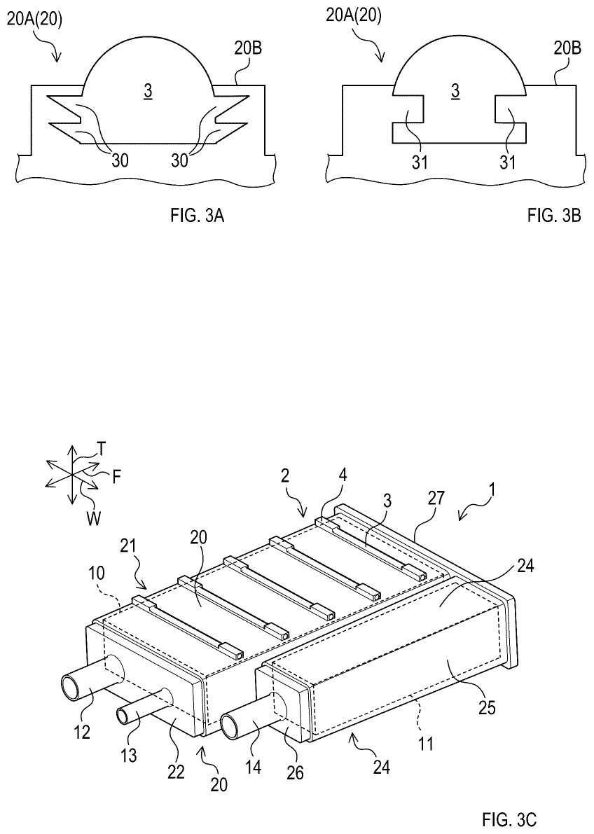

Specifically, each of the first horizontal walls 20 includes bases 20B each protruding from the outer circumferential surface 20A (see FIG. 3A). Each of the bases 20B is formed as a rib-like portion extending from a first end to a second end of the horizontal walls 20 substantially along the width directions W. Each of the reinforcing members 3 is arranged with a portion thereof being embedded in a corresponding one of the bases 20B. The reinforcing members 3 may be disposed on the first horizontal walls 20 that includes no bases 20B.

In one example, the part of each of the reinforcing members 3 exposed from a corresponding one of the bases 20B is situated over the entire length of each of the reinforcing members 3, in other words, from the first end to the second end of each of the reinforcing members 3 in the width directions W. However, without being limited to this configuration, such an exposed portion may be situated at a portion of the entire length of each of the reinforcing members 3. Alternatively, each of the reinforcing members 3 may be disposed with its entirety embedded inside a corresponding one of the first horizontal walls 20, or with a portion of each of the reinforcing members 3 exposed to the first chamber 10.

### <Projected Portion or Recessed Portion of Reinforcing Member>

Each of the reinforcing members 3 includes at least one projected portion 30 (four projected portions 30, as one example) on the outer circumferential surface thereof (see FIG. 3A). Each of the reinforcing members 3 is arranged with its projected portions 30 embedded in the corresponding one of the bases 20B. The projected portions 30 are disposed on the outer circumferential surface of each of the reinforcing members 3 on both sides in the width directions and are projecting in the width directions of the reinforcing members 3. As one example, each of the projected portions 30 is formed as a rib-like portion extending from the first end to the second end of each of the reinforcing members 3. However, without being limited to this configuration, the projected portions 30 may be configured as protrusions arranged side by side with each other along extending directions of the reinforcing members 3.

In place of or in addition to the at least one projected portion 30, at least one recessed portion 31 (two recessed portions 31, as one example) may be disposed on the outer circumferential surface of each of the reinforcing members 3 (see FIG. 3B). Each of the reinforcing members 3 is arranged with its recessed portions 31 embedded in the corresponding one of the bases 20B. The recessed portions 31 are disposed on the outer circumferential surface of each of the reinforcing members 3 on both sides in the width directions of the reinforcing members 3. As one example, each of the recessed portions 31 is formed as a groove-like portion extending from the first end to the second end of each of the reinforcing members 3. However, without being limited to this configuration, the recessed portions 31 may be configured as holes arranged side by side with each other along the extending directions of the reinforcing members 3.

### 2. Second Embodiment

### [(1) Overview]

The canister 1 of a second embodiment is different from the canister 1 of the first embodiment in a method of attaching the reinforcing members 3 to the first horizontal walls 20 (see FIG. 3C). Specifically, in the second embodiment, similarly to the first embodiment, the reinforcing members 3 extending substantially in the width directions W are arranged on the first horizontal walls 20. However, the second embodiment is different from the first embodiment in that each of the reinforcing members 3 is engaged with a corresponding one of the first horizontal walls 20. Differences between the canister 1 of the second embodiment and the canister 1 of the first embodiment will be explained below.

### [(2) Engagement Portion]

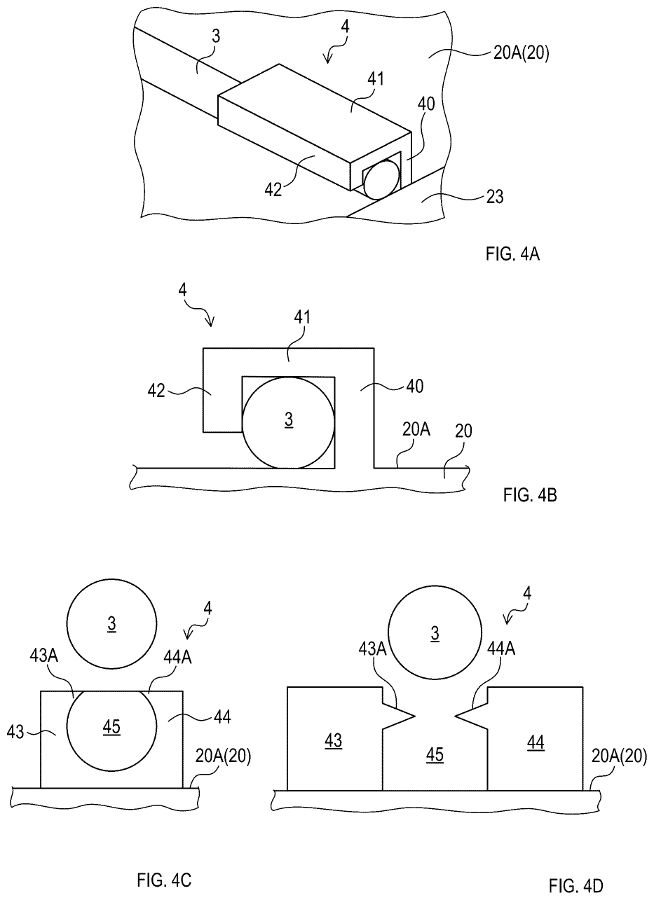

The canister 1 of the second embodiment includes engagement portions 4 each disposed on the outer circumferential surface 20A of each of the first horizontal walls 20 (see FIG. 3C to FIG. 4B). Each of the engagement portions 4 is configured to engage with one of the reinforcing members 3.

Specifically, the engagement portions 4 are arranged side by side with each other along edges, situated on both sides in the width directions W, of the outer circumferential surface 20A of each of the first horizontal walls 20. Each engagement portion 4 along one of the edges faces with one of the engagement portions 4 at the other one of the edges in the width directions W. Both ends of each reinforcing members 3 engage with two engagement portions 4 that faces each other in the width directions W, and the reinforcing members 3 are arranged on the outer circumferential surface 20A while extending in the width directions W.

Specifically, each engagement portion 4 includes a protrusion 40, a ceiling 41, and a leading end 42 (see FIG. 4B).

The protrusion 40 is a wall-like portion that protrudes from the outer circumferential surface 20A of the first horizontal walls 20 in the thickness directions T and extends in the width directions W.

The ceiling 41 is a portion that protrudes from a top portion of the protrusion 40 in a first direction (or a second direction) in the fluid flow directions F.

The leading end 42 is a portion that protrudes from an end portion of the ceiling 41 opposite to the protrusion 40 toward the outer circumferential surface 20A. A clearance is formed between the leading end 42 and the outer circumferential surface 20A.

In other words, a space for housing the reinforcing member 3 is formed inside the protrusion 40, the ceiling 41, and the leading end 42. Thus, once the reinforcing member 3 is pressed into the aforementioned clearance between the leading end 42 and the outer circumferential surface 20A, the engagement portion 4 is elastically deformed to house the reinforcing member 3 in the space, and thereby the engagement portion 4 engages with the reinforcing member 3.

The position of the engagement portion 4 can be appropriately determined without being limited to the both ends of the outer circumferential surface 20A of the first horizontal walls 20 in the width directions W. The engagement portion 4 may be, for example, situated away from an end of the outer circumferential surface 20A in the width directions W, and each of the reinforcing members 3 may be attached to the outer circumferential surface 20A by engaging with a single engagement portion 4 or three or more engagement portions 4.

### (3) Modified Example 1

In a canister 1 of a modified example 1 of the second embodiment, the engagement portion 4 includes a first base 43 and a second base 44 that protrude from the outer circumferential surface 20A of the first horizontal walls 20 (see FIG. 4C and FIG. 4D). The first and second base 43, 44 extend substantially along the width directions W and are arranged at a given interval in the fluid flow directions F. A groove 45 is formed between these bases. The first base 43 includes a leading end 43A that is situated at the top or near the top of the first base 43 and protrude toward the second base 44. The second base 44 includes a leading end 44A that is situated at the top or near the top of the second base 44 and protrude toward the first base 43. A clearance is formed between the leading end 43A and the leading end 44A.

Specifically, as shown in FIG. 4C, the engagement portion 4 may be formed as a rib-like portion protruding from the outer circumferential surface 20A of the first horizontal walls 20, and the groove 45 may be formed at the top of the engagement portion 4. The first and second bases 43, 44 may be disposed so as to keep the groove 45 therebetween. A cross section of the reinforcing member 3 perpendicular to the width directions W may have a circular shape, and a cross section of the groove 45 perpendicular to the width directions W may have a roughly circular shape. However, the shapes of these cross sections can be appropriately determined without being limited thereto.

Apart from the above, as shown in FIG. 4D, the first and second bases 43, 44 of the engagement portion 4 may also be portions having rectangular parallelepiped shapes that protrude from the outer circumferential surface 20A of the first horizontal walls 20.

Once the reinforcing member 3 is pressed into the groove 45 of the engagement portion 4, the first and second bases 43, 44 and the leading ends 43A, 44A are elastically deformed to house the reinforcing member 3 inside the groove 45, and thereby the engagement portion 4 engages with the reinforcing member 3.

### (4) Modified Example 2

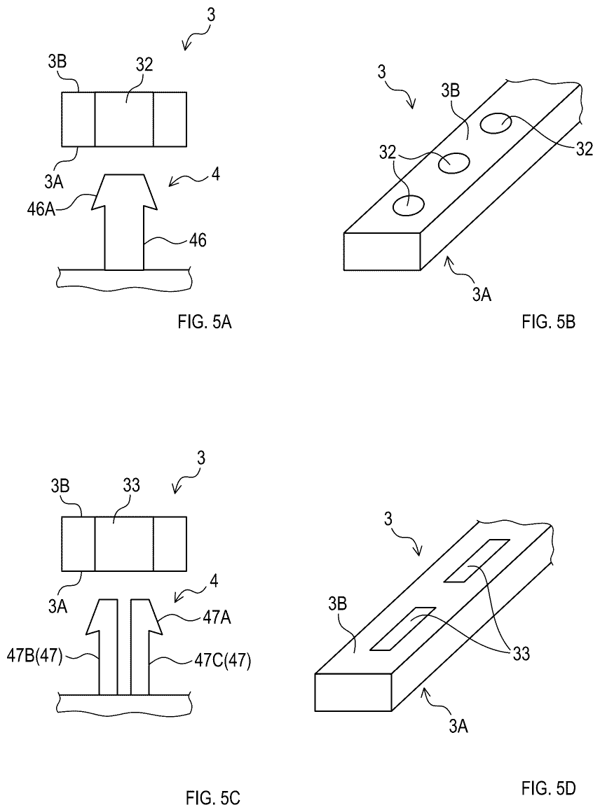

In a canister 1 of a modified example 2 of the second embodiment, the engagement portion 4 includes at least one protrusion 46 or at least one protrusion 47 that protrudes from the outer circumferential surface 20A of the first horizontal walls 20 (see FIG. 5A and FIG. 5C). Each of the at least one protrusion 46 includes a leading end 46A that protrudes from an area near the top of an outer circumferential surface of the at least one protrusion 46. Each of the at least one protrusion 47 includes a leading end 47A that protrudes from an area near the top of an outer circumferential surface of the at least one protrusion 47.

The reinforcing member 3 includes at least one hole 32 or at least one hole 33 that penetrates the reinforcing member 3 (see FIG. 5B and FIG. 5D). Each of the at least one hole 32 extends from a first surface 3A to a second surface 3B of the reinforcing member 3 situated on an opposite side of the first surface 3A and allows each of the at least one protrusion 46 to be inserted therethrough. Each of the at least one hole 33 extends from the first surface 3A to the second surface 3B of the reinforcing member 3 situated on an opposite side of the first surface 3A and allows each of the at least one protrusion 47 to be inserted therethrough.

The reinforcing member 3 engages with the engagement portion 4 by inserting the at least one protrusion 46 or the at least one protrusion 47, forming the engagement portion 4, respectively through the at least one hole 32 or the at least one hole 33 in the reinforcing member 3 from the first surface 3A. At this time, the leading end 46A and the leading end 47A project from the second surface 3B and are hooked on the second surface 3B.

Specifically, as shown in FIG. 5A and FIG. 5B, the engagement portion 4 may include at least two (three, as one example) protrusions 46 having a circular cylindrical shape. The leading end 46A may be disposed to surround the outer circumferential surface of the at least two protrusions 46. The reinforcing member 3 may include at least two (three, as one example) holes 32 that can allow the at least two protrusions 46 to be inserted therethrough. These holes 32 are arranged along the extending directions of the reinforcing member 3.

According to such a configuration, once the at least two protrusions 46 are pressed into the at least two holes 32 of the reinforcing member 3 from the first surface 3A, the at least two protrusions 46 pass through the at least two holes 32 while being elastically deformed. Then, the leading end 46A protrudes from the second surface 3B and is hooked on the second surface 3B. The reinforcing member 3 thereby engages with the engagement portion 4.

Apart from the above, as shown in FIG. 5C and FIG. 5D, the engagement portion 4 may include at least two (two, as one example) protrusions 47 having a plate shape and extending substantially in the width directions W, for example. Each protrusion 47 included in the at least two protrusions 47 includes a slit at the center thereof in the thickness directions. The slit extends from a first end to a second end of the protrusion 47 in the width directions W and divides the protrusion 47 into a first part 47B and a second part 47C. The protrusion 47 includes the leading end 47A near the top of a surface of each of the first and second parts 47B, 47C opposite to the slit. The reinforcing member 3 may include at least two (two, as one example) long and narrow holes 33 that allow the at least two protrusions 47 to be inserted therethrough. The at least two holes 33 are arranged along the extending directions of the reinforcing member 3 and extend in the extending directions.

According to such a configuration, the reinforcing member 3 can be engaged with the engagement portion 4 by snap-fit (mechanism). In other words, once the at least two protrusions 47 are inserted through the at least two holes 33 of the reinforcing member 3 from the first surface 3A, each of the at least two protrusions 47 passes through a corresponding one of the at least two holes 33 while being elastically deformed such that the first part 47B and the second part 47C approach each other. Then, the leading end 47A protrudes from the second surface 3B and is hooked on the second surface 3B. The reinforcing member 3 thereby engages with the engagement portion 4.

### 3. Third Embodiment

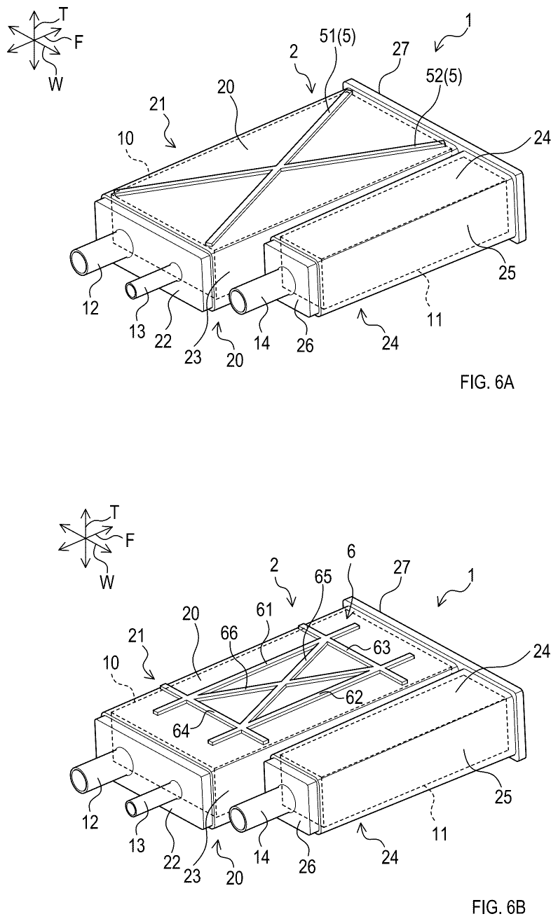

The canister 1 of a third embodiment is different from the canister 1 of the first embodiment in the shape of reinforcing members 5, 6 (see FIG. 6A and FIG. 6B). Specifically, the reinforcing members 5, 6 of the third embodiment include parts that extend in different directions. In the third embodiment, the reinforcing members 5, 6 may be disposed on the first horizontal walls 20 by insert-molding similarly to the first embodiment or may engage with the outer circumferential surface 20A of the first horizontal walls 20 similarly to the second embodiment.

In one example, as shown in FIG. 6A, the reinforcing member 5 may include a first part 51 and a second part 52 extending linearly. The first part 51 and the second part 52 are arranged along diagonal lines on the first horizontal walls 20 and intersect each other at roughly the center of the first horizontal walls 20.

In one example, as shown in FIG. 6B, the reinforcing member 6 may include a first part 61, a second part 62, a third part 63, a fourth part 64, a fifth part 65, and a sixth part 66 extending linearly.

The first and second parts 61, 62 extend substantially along the fluid flow directions F and are arranged substantially in the width directions W. The first part 61 is situated close to the first vertical wall 21, and the second part 62 is situated close to the intermediate wall 23.

The third and fourth parts 63, 64 extend substantially along the width directions W and are arranged substantially in the fluid flow directions F. The third part 63 is situated close to the lid 27, and the fourth part 64 is situated close to the first end wall 22.

Each of the first and second parts 61, 62 intersects the third and fourth parts 63, 64. The fifth part 65 extends from a point of intersection between the first part 61 and the third part 63 to a point of intersection between the second part 62 and the fourth part 64. The sixth part 66 extends from a point of intersection between the first part 61 and the fourth part 64 to a point of intersection between the second part 62 and the third part 63.

### 4. Effects

(1) If the canister is made to have a flat shape, the stiffness of the case is reduced, causing the case to dilate or bend under heat and pressure. This leads to a decrease in filling density of the activated carbon disposed inside the case and also to a decrease in load applied by a spring holding the activated carbon. As a result, there is a concern that the activated carbon is broken into pieces due to vibration from the vehicle. To avoid such a circumstance, it is conceivable to improve the stiffness of the case by increasing the thickness of the case and by increasing the number of the ribs, which, however, may increase the volume and the weight of the canister.

In this regard, the canister 1 of the aforementioned embodiments includes at least two reinforcing members 3, 5, 6 on the first horizontal walls 20, and the at least two reinforcing members 3, 5, 6 are made of a material having a stiffness higher than the stiffness of the resin for the case 2. Thus, it is possible to reinforce the case 2 while inhibiting an increase in the material for the case 2, in other words, inhibiting the volume and/or the weight of the case 2 from increasing. Accordingly, it is possible to improve the strength of the canister 1 while inhibiting a decrease in installability of the canister to the vehicle.
(2) The first horizontal walls 20 of the first chamber 10 having a flat shape may dilate or bend. In this regard, according to the aforementioned embodiments, the first horizontal walls 20 can be favorably reinforced by the at least two reinforcing members 3, 5, 6, and thereby it is possible to inhibit the first horizontal walls 20 from dilating or bending.
(3) The case 2 is made of a resin, and the at least two reinforcing members 3, 5, 6 are made of metal or a resin containing a glass fiber. Thus, it is possible to favorably reinforce the case 2.
(4) According to the first embodiment, each of the reinforcing members 3 is disposed on the outer circumferential surface 20A of the first horizontal walls 20 with a part thereof exposed from the outer circumferential surface 20A. As a result, compared to a case where a whole of each of the reinforcing members 3 is embedded in the first horizontal walls 20, it is possible to reduce the thickness of the first horizontal walls 20 and to inhibit an increase in the material of the case 2. Thus, it is possible to reduce a space in the vehicle for installing the canister 1 and to reduce the weight of the canister 1.
(5) According to the first embodiment, the part of each of the reinforcing members 3 embedded in the first horizontal walls 20 includes at least one recessed portion 30 and/or at least one projected portion 31. Thus, it is possible to inhibit the reinforcing members 3 from being detached from the first horizontal walls 20.
(6) According to the second embodiment, each of the reinforcing members 3 is attached to the outer circumferential surface 20A by engaging with the engagement portion 4 disposed on the outer circumferential surface 20A of the first horizontal walls 20. Thus, it is possible to favorably attach the reinforcing members 3 on the first horizontal walls 20.

### 5. Other Embodiment

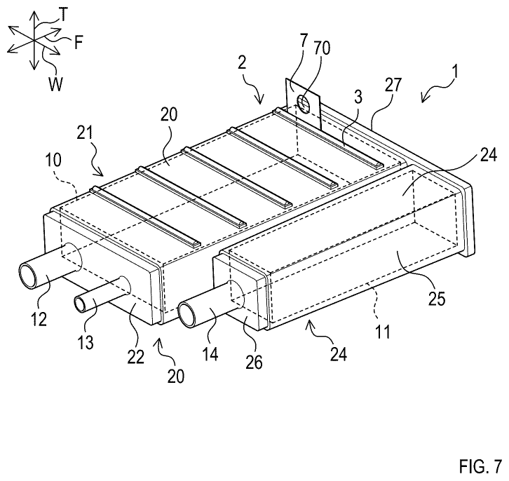

(1) In the first to third embodiments, the reinforcing member 3 may include an attachment 7 (see FIG. 7). The attachment 7 may be used to install the canister 1 on the body of the vehicle, or to attach members installed in the vehicle such as a harness or harness clips disposed on the vehicle. The attachment 7 in FIG. 7 includes a through-hole 70 as one example. The canister 1 may be installed on the body of the vehicle via the through-hole 70, or the members installed in the vehicle may be attached to the canister 1 through the through-hole 70.

Furthermore, the reinforcing members 3 including different attachments 7 may be disposed depending on the type of the vehicle on which the canister 1 is installed. This allows the canister 1 to be installed on various types of vehicles without making any changes in the canister 1 itself.
(2) Functions of one element in the aforementioned embodiments may be achieved by two or more elements, and a function of one element may be achieved by two or more elements. Functions of two or more elements may be achieved by one element, and a function achieved by two or more elements may be achieved by one element. A part of the configuration of the aforementioned embodiments may be omitted. At least a part of the configuration of the aforementioned embodiments may be added to or replaced with other configurations of the aforementioned embodiments.

### 6. Technical Ideas Disclosed in the Specification

[Item 1]

A canister that adsorbs and desorbs an evaporated fuel generated in a fuel tank of a vehicle, the canister comprising:
a case; and
at least one reinforcing member,
the case including therein a chamber, in which an adsorbent for the evaporated fuel is disposed, and also including a charge port that takes in the evaporated fuel, a purge port that discharges the evaporated fuel, and an atmosphere port that is open to atmosphere,
the at least one reinforcing member being a long and narrow member situated on a wall of the case facing the chamber, and
a material of the at least one reinforcing member having higher stiffness than a material of the case.
[Item 2]

The canister according to item 1,
wherein the chamber includes a first chamber having a flat shape,
wherein the wall of the case forming the first chamber includes two wide-width portions facing each other in thickness directions that are perpendicular to fluid flow directions, and two narrow-width portions facing each other in width directions that are perpendicular to the fluid flow directions and the thickness directions,
wherein an interval between the two wide-width portions in the thickness directions is narrower than an interval between the two narrow-width portions in the width directions, and
wherein the at least one reinforcing member is situated on at least one of the two wide-width portions.
[Item 3]

The canister according to item 1 or 2,
wherein the at least one reinforcing member is made of metal.
[Item 4]

The canister according to any one of items 1 to 3,
wherein the at least one reinforcing member is made of a resin containing a glass fiber.
[Item 5]

The canister according to any one of items 1 to 4,
wherein each of the at least one reinforcing member is embedded into the wall of the case such that a part of each of the at least one reinforcing member is exposed outside, and
wherein a part of each of the at least one reinforcing member embedded into the wall includes a recessed portion and/or a projected portion.
[Item 6]

The canister according to any one of items 1 to 5,
wherein each of the at least one reinforcing member is situated on the wall of the case by engaging with an engagement portion disposed on an outer circumferential surface of the wall of the case.

What is claimed is:

1. A canister that adsorbs and desorbs an evaporated fuel generated in a fuel tank of a vehicle, the canister comprising:
a case; and
at least one reinforcing member,
the case including therein a chamber, in which an adsorbent for the evaporated fuel is disposed, and also including a charge port that takes in the evaporated fuel, a purge port that discharges the evaporated fuel, and an atmosphere port that is open to atmosphere,
the at least one reinforcing member being a long and narrow member situated on a wall of the case facing the chamber, and
a material of the at least one reinforcing member having higher stiffness than a material of the case.

2. The canister according to claim 1,
wherein the chamber includes a first chamber having a flat shape,
wherein a portion of the wall of the case forming the first chamber includes two wide-width portions facing each other in thickness directions that are perpendicular to fluid flow directions, and two narrow-width portions facing each other in width directions that are perpendicular to the fluid flow directions and the thickness directions,
wherein an interval between the two wide-width portions in the thickness directions is narrower than an interval between the two narrow-width portions in the width directions, and
wherein the at least one reinforcing member is situated on at least one of the two wide-width portions.

3. The canister according to claim 2,
wherein the first chamber includes the charge port and the purge port.

4. The canister according to claim 1,
wherein the at least one reinforcing member is made of metal.

5. The canister according to claim 1,
wherein the at least one reinforcing member is made of a resin containing a glass fiber.

6. The canister according to claim 1,
wherein each of the at least one reinforcing member is embedded into the wall of the case such that a part of each of the at least one reinforcing member is exposed outside, and
wherein a part of each of the at least one reinforcing member embedded into the wall includes a recessed portion and/or a projected portion.

7. The canister according to claim 1,
wherein each of the at least one reinforcing member is situated on the wall of the case by engaging with an engagement portion disposed on an outer circumferential surface of the wall of the case.

8. The canister according to claim 1,
wherein the at least one reinforcing member includes two or more reinforcing members, and
wherein the two or more reinforcing members are arranged side by side with one another in a given direction.

9. The canister according to claim 2,
wherein the at least one reinforcing member includes two or more reinforcing members, and
wherein the two or more reinforcing members are arranged side by side with one another in a given direction on at least one of the two wide-width portions.

10. The canister according to claim 9,
wherein the two or more reinforcing members are arranged side by side with one another substantially in the fluid flow directions.

11. The canister according to claim 9,
wherein the two or more reinforcing members are arranged side by side with one another substantially in the width directions.
